(19) United States
(12) Patent Application Publication
(10) Pub. No.: US 2004/0082492 A1
(43) Pub. Date: Apr. 29, 2004

(54) Biocidal plastics internal elements for mass transfer apparatus

(76) Inventors: Urs Kohler, Pratteln (CH); Christian Schori, Lausen (CH); Christian Stuerchler, Allschwil (CH); Gerhard Stucki, Ormalingen (CH); Markus Thuer, Rheinfelden (CH); Heinz Herbst, Lorrach (DE); Nikolaus Thissen, Dielheim (DE)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/468,940

(22) PCT Filed: Feb. 18, 2002
(86) PCT No.: PCT/EP02/01686

(30) Foreign Application Priority Data
Feb. 26, 2001 (EP) 01810196.4

(51) Int. Cl. C11D 3/48

(52) U.S. Cl. 510/383; 510/384

(57) ABSTRACT

The invention relates to biocide-containing active plastics internal elements for the cleaning of gas or air in humidifiers of process gases, gas scrubbers or exhaust air scrubbers in which a gas phase and a liquid phase are in contact with one another, the biocide being selected from the group consisting of 2,3,5,6-tetrachloro-4-(methylsulfonyl)-pyridine, 2,4,4′-trichloro-2′-hydroxy-diphenyl ether, 4,4′-dichloro-2-hydroxyphenyl ether, 2,2′-methylenebis(4-chlorophenol), 4-(2-tert-butyl-5-methylphenoxy)-phenol, 3-(4-chlorophenyl)-1-(3,4-dichlorophenyl)urea and 2,4,6-trichlorophenol. The invention relates also to the use of the above biocides in plastics internal element for the cleaning of gas or air in humidifiers of process gases, gas scrubbers or exhaust air scrubbers.

The present invention relates to active plastics internal elements that have been provided with biocidal properties in mass transfer apparatus, especially exhaust air scrubbers, flue gas scrubbers, or humidifiers of process gases. The invention relates also to the use of biocidal substances in plastics internal elements of such mass transfer apparatus.

Mass transfer apparatus, especially exhaust air scrubbers, flue gas scrubbers, humidifiers of process gases, as employed in the industrial sector, generally comprise a plurality of active plastics internal elements fundamental to the functioning of the apparatus, which elements serve to create large surface areas in the reaction chamber and to guide flows of gas and water in such a manner that mass transfer is able to take place as efficiently as possible.

The apparatus generally consist of cylindrical or parallelepipedal reaction chambers that contain such plastics internal elements. Typically, an aqueous liquid is sprayed in at the head of the reactor and the liquid trickles down over the active internal elements under the action of gravity to the foot of the column, from where e.g. it is returned by pumps to the top via a filter, thus creating a closed circulating flow of liquid to which fresh water and further chemicals can be supplied or from which portions of liquid can be removed, as required.

In counter-current operation, the flow of gas to be treated is fed in at the foot of the column and blown upwards towards the head of the column, there taking place on the internal components a mass and heat transfer in which, for example, flue gases and waste gases are cleaned, the impurities being flushed with the liquid to the foot of the column, where they can be removed.

In addition to the courtier-current flow of gas and liquid described, co-current and cross-current flows are also known and used.

Many areas of process engineering and processing technology utilise apparatus for humidifying and cooling process gas and air flows by means of so-called “adiabatic humidification”.

In that process, the gas flows through an apparatus in which it is brought into contact with water. As a result of the contact between the water and the gas, a mass transfer takes place by means of which water passes from the liquid phase by evaporation to the gas phase (evaporation), as a result of which the gas is humidified. The removal of heat necessitated by the evaporation results simultaneously in a lowering of the temperature. The contact between gas and water can be brought about by direct contact between sprayed water droplets and the gas. In such a case (spray humidifiers) no further internal components are necessary. The contact between water and gas can also be effected, however, by spraying the water from above onto mass exchangers (packings, filling materials, connected structures) arranged in the apparatus. The water runs from the top to the bottom over such internal components, while the gas flows around those components. As a result, the surface area of the water and the dwell time of the water in the mass exchange zone is increased and the mass exchange with respect to the gas is improved.

In such apparatus, humidification until the concentration of water in the gas is close to saturation is possible. The use of temperature-controlled water for humidification enables the moisture content and temperature of the gas to be influenced in a specific manner.

The internal components should be such that they have as great as possible a surface area and distribute the gas and water flow uniformly throughout the entire reaction chamber, but do not impede the flow of gas and water to any appreciable extent and thus do not result in an excessive build-up of pressure.

Important active plastics internal elements are packings, which either fill the reaction chamber loosely, e.g. Raschig rings, or are used in ordered structures. Such loose rings and ordered structures are commercially available.

Further active plastics internal elements that are frequently used include nozzles that taper and then widen again, through which the flow of gas is guided. Such gas guide inserts create a venturi effect and thus ensure particularly efficient intermixing of air and water. Suitable gas guide inserts are described, for example, in DE OS 28 51 176.

Further frequently used active plastics components are droplet separators, which are usually arranged shortly b for the air outlet opening and ensure that the outgoing air carries as little moisture as possible to the outside. Droplet separators are known components and can be incorporated in a large number of geometric variants. Those described in U.S. Pat. No. 3,925,040 are especially suitable.

The gases flowing through are often contaminated with organically degradable material, which leads to the undesirable formation of microbial material on the plastics internal elements. The consequences range from a deterioration in the hydraulics and gas flow to complete clogging of the system. It is then usually necessary for the individual plastics internal elements to be cleaned or to be exchanged and replaced by fresh material. That is time-consuming, expensive and harmful to the environment.

In order to be able to avoid that situation it is possible, for example, to add biocides to the circulating flow of water so that the build-up of microbial growth on plastics internal elements can be suppressed.

That procedure, however, requires constant monitoring of the water for its content of biocide. There is always a risk with that procedure that too much or too little biocide will be added. When adding the biocidal substances to the circulating water it is also possible that an undesirable release of the substances into the environment will occur, especially if the handling of such substances is inadequately supervised and/or carried out by insufficiently qualified personnel. There continues to be a need, therefore, to prevent the build-up of microbial growth on plastics internal elements while at the same time avoiding the disadvantages associated with the handling of concentrated biocidal substances.

It has now been found, surprisingly, that certain biocides can be incorporated directly into plastics internal elements during the manufacture thereof, without those biocides being destroyed and rendered inactive as a result of the processing conditions. The incorporated biocides surprisingly retain their full activity and display that activity only on the surface of the internal components that is to be protected against the build-up of biological growth, with the result that no biological material is formed and there is no build-up of growth. There is virtually no release of biocidal substance into the water, or at most only to an insignificant extent, so that virtually no ecological damage is caused. There is no longer any need to handle concentrated biocides at the gas cleaning site, so that monitoring of the amounts added or for incorrect handling is totally unnecessary. The activity of the incorporated biocides is retained over a prolonged period and may last for several years, depending upon the degree of loading to which the internal components are subjected, so that the plastics internal elements can be used for long periods without being replaced.

At the same time, the use of plastics internal elements that have been provided with biocidal properties achieves a hygienic effect, since (because the formation of biological material is avoided or suppressed) less microbial material is able to escape into the air.

The invention relates to biocide-containing active plastics internal elements for the cleaning of gas or air in humidifiers of process gases, gas scrubbers or exhaust air scrubbers in which a gas phase and a liquid phase are in contact with one another, the biocide being selected from the group consisting of 2,3,5,6-tetrachloro+(methylsulfonyl)-pyridine, 2,4,4′-trichloro-2′-hydroxydiphenyl ether, 4,4′-dichloro-2-hydroxydiphenyl ether, 2,2′-methylenebis(4-chlorophenol), 4-(2-tert-butyl-5-methylphenoxy)-phenol, 3-(4-chlorophenyl)-1-(3,4-dichlorophenyl)urea and 2,4,6-trichlorophenol.

Biocides within the scope of the present invention are substances which have a biological activity with respect to microorganisms and, for example, prevent their formation and growth or cause microorganisms already present to die. Typical microorganisms are bacteria, algae and fungi. Accordingly the term biocidal includes bactericidal, algicidal and fungicidal.

An active plastics internal element in the context of the present invention is to be understood as being a plastics component that is fundamental to the operation of the apparatus.

Preferred biocide-containing active plastics internal elements are plastics packings, gas guide inserts and plastics droplet separators.

Plastics packings are especially preferred.

The plastics internal elements can be produced by blowing processes (films), extrusion, deep-drawing or casting processes, injection moulding or rotational casting.

When the internal elements are plastics packings, they may be of any desired shape per se. They may b ordered or unordered structures. Examples of unordered structures are described, for example, in “Thermische Trennverfahren—Aufgaben and Lösungen, Auslegungs-beispiele”, K. Sattler 1977, page 86, Vogel Verlag, Wurzburg. They may be, for example, rings, spheres, cylindrical tubes or specially optimised geometric shapes. Examples of specially optimised geometric shapes are also described in U.S. Pat. No. 4,072,736. The embodiments described therein are especially suitable packings in the context of the present invention. Such packings consist essentially of parallel rods, the lengths of which are such that the overall shape of the packing is substantially spherical or ellipsoidal. Suitable embodiments are described in U.S. Pat. No. 4,072,736.

Ordered structures are also known and are commercially available, for example, from Sulzer Anlagenbau or from Munters Euroform GmbH.

When the plastics internal elements are plastics droplet separators, then in principle any commercially available geometric shape can be provided with biocide. Those described in U.S. Pat. No. 3,925,040 are especially suitable.

Especially suitable gas guide inserts create a venturi effect and thereby ensure particularly efficient intermixing of air and water. Suitable gas guide inserts are described, for example, in DE OS 28 51 176. They are especially preferred in the context of the present invention.

Preference is given to the use of such active plastics internal elements for the cleaning of gas and air in gas scrubbers or exhaust air scrubbers.

Preferred biocides are 2,4,4′-trichloro-2′-hydroxydiphenyl ether and 4,4′-dichloro-2-hydroxy-diphenyl ether.

The compounds as such are known and are commercially available.

The biocidally active compound is preferably used in an amount of from 0.001 to 5 % by weight, especially from 0.02 to 1% by weight and more especially from 0.05 to 1% by weight, based on the plastics.

Suitable plastics for the manufacture of packings are in principle any thermosetting or thermoplastic plastics. Active plastics internal elements manufactured from polyolefins have proved to be especially suitable, however, and these are accordingly preferred. They are especially preferably manufactured from polyethylene or polypropylene.

The biocidally active compound can be added in the form of a pure substance or in the form of a mixture with other plastics (master batch), for example LDPE, HDPE or PP.

Selected plastics suitable for the process are indicated below:

1. Polymers of monoolefins and diolefins, for example polypropylene, polyisobutylene, polybut-1-ene, poly4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:

a) radical polymerisation (normally under high pressure and at elevated temperature).

b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylenelcycloolefin copolymers (e.g. ethylene/norbomene like COC), ethylene/1-olefins copolymers, where the 1-olefin is generated in-situ; propylenelbutadiene copolymers, isobutylenelisoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethyleneacrylic acid copolymers (EM), LLDPE/EVA, LLDPE/EM and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadienelalkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styren and acrylonitrile (or methacrylonitrile) on polybutadiene; styrene, acrylonitrile and methyl methacrylate on polybutadiene; styrene and maleic anhydride on polybutadiene; styrene, acrylonitril and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/ alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxym thylen and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or polyphenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POMWMBS, PPO/HIPS, PPO/PA 6.6 and copolymers, PA/HDPE, PA/PP, A/PNPO, PST/PC/ABS or PBT/PET/PC.

In principle, it is also possible for the biocidally active compound to be added as early as the preparation of the polymers, provided that it has no effect on the preparation process.

In practice, active ingredients are frequently used in combination with other biocides. For example, the preferred compounds can be combined with Cu₂O, CuSCN, triorganotin compounds, e.g. tributyltin oxide, tributyltin fluoride and triphenyltin chloride, silver, silver compounds, e.g. Ag₂O, AgCl, AgNO₃, Ag₂SO₄, silver-zeolite, silver-glass, silver zirconates, thiabendazole, tebuconazole, 10,10′-oxybis-phenoxyarsine, zinc pyrithione, 2-n-octyl4-isothiazolin-3-one, n-butyl-1,2-benzisothiazolin-3-one, 4,5-dichloro-N-n-octyl-isothiazolin-3-one, metallic copper, ZnO or triazines, or generally with compounds which are known to the person skilled in the art as being effective against the build-up of animal or plant growth. The person skilled in the art will find suitable compounds e.g. in “The Pesticide Manual”, published by: British Crop Protection Council, 1997.

In addition to further biocides, the plastics may also additionally comprise one or more components from the group of pigments, dyes, fillers, adhesion promoters, anti-oxidants and light-stabilisers.

The pigments are, for example, carbon black, graphite, titanium dioxide, iron oxide, aluminium bronze, phthalocyanines and organic coloured pigments, and also blends thereof with inorganic pigments.

Examples of fillers are talc, aluminium oxide, aluminium silicate, barytes, mica, glass fibres, glass beads and silicon dioxide.

The biocidally active compounds can also be applied to a carrier (e.g. zeolites) and incorporated together with that carrier.

The plastics preferably comprises additional processing stabilisers and/or light stabilisers. Examples are given below.

1. Antioxidants

1.1. Alkylated monophenols, for example 2,6-di-tert-butyl4-methylphenol, 2-tert-butyl4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example 2,6di-nonyl4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl4-nonylphenol.

1.3. Hydroquinones and alkylated hydroquinones, for example 2,6-di-tert-butyl4-methoxyphenol, 2,5-di-tert-butylhydroquinone, 2,5di-tert-amylhydroquinone, 2,6-diphenyl-4-ctadecyloxyphenol, 2,6-di-tert-butylhydroquinone, 2,5-di-tert-butyl-4-hydroxyanisole, 3,5-di-tert-butyl-4-hydroxyanisole, 3,5di-tert-butyl4-hydroxyphenyl stearate, bis(3,5di-tert-butyl4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6di-sec-amylphenol), 4,4′-bis(2,6-dimethyl-4-hydroxyphenyl)-disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl4-methylphenol), 2,2′-methylenebis(4,6di-tert-butylphenol), 2,2′-ethylidenebis(4,6-di-tert-butylphenol), 2,2′-ethylid nebis(6tert-butyl4isobutylphenol), 2,2′-methylenebis[6-(α-methylbenzyl)-4-nonylphenol], 2,2′-methylenebis[6-(α, α-dimethylbenzyl)4nonylphenoll, 4,4′-methylenebis(2,6-di-tert-butylphenol], 4,4′-methylenebis(6-tert-butyl-2-methylphenol), 1,1-bis(5-tert-butyl4-hydroxy-2-methylphenyl)butane, 2,6-bis(3-tert-butyl-5-methyl-2-hydroxybenzyl)4-methylphenol, 1,1,3-tris(5-tert-butyl-4-hydroxy-2-methylphenyl)butane, 1,1-bis(5-tert-butyl4-hydroxy-2-methylphenyl)-3-n-dodecylmercaptobutane, ethylene glycol bis[3,3-bis(3′-tertbutyl4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl methylphenyllterephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra(5-tert-butylphydroxy-2-methylphenyl)pentane.

1.7. O—, N— and S-benzyl compounds, for example 3,5,3′,5′-tetra-tert-butyl4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-1-tert-butyl-4-hydroxybenzyl)amine, bis-(4tert-butyl-3-hydroxy-2,6-dimethylbenzyl)dithioterephthalate, bis(3,5p-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl~hydroxybenzyl)malonate.

1.9. Aromatic hydroxybenzyl compounds, for example 1,3,5-tris(3,5-di-tert-butyl4-hydroxybenzyl)-2,4,6-trimethylbenzene, 1,4-bis(3,5-di-tert-butyl4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl4hydroxyanilino)-1,3,5-triazine, 2-octylmercapto-4,6-bis(3,5-di-tert-butyl-4-hydroxyanilino)-1,3,5-triazine, 2-octylmercapto4,6-bis(3,5-di-tert-butyl-4-hydroxyphenoxy)-1,3,5-triazine, 2,4,6-tris-(3,5-di-tert-butyl4-hydroxyphenoxy)-1,2,3-triazine, 1,3,5-tris(3,5-di-tert-butyl4-hydroxybenzyl)isocyanurate, 1,3,5-tris(4-tert-butyl-3-hydroxy-2,6dimethylbenzyl)isocyanurate, 2,4,6-tris-(3,5-di-tert-butyl4hydroxyphenylethyl)-1,3,5-triazine, 1,3,5-tris(3,5-di-tert-butyl4-hydroxyphenylpropionyl)-hexahydro-1,3,5-triazine, 1,3,5-tris(3,5-dicyclohexyl4hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5di-tert-butyl-4-hydroxybenzylphosphonic acid.

1.12. Acylaminophenols, for example 4-hydroxylauranilide, 4-hydroxystearanilide, octyl N-(3,5-di-tert-butyl4-hydroxyphenyl)carbamate.

1.13. Esters of β-(3.5-di-tert-butyl-4-hydroxyphenyl)Dropionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis(2-{3-(3-tertbutyl-4-hydroxy-5-methylphenyl)propionyloxy}-1,1-dimethylethyl]-2,4,8,1 0-tetraoxaspiro[5.5]-undecane.

1.15. Esters of 13-(3.5-dicyclohexyl-4-hydroxyphenyl)Dropionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1 -phospha-2,6,7-trioxabicyclo[2.2.2]octane.

1.16. Esters of 3.5-di-tert-butylphydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethyl n glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1 -phospha-2,6,7-trioxabicyclo[2.2.2]octane.

1.17. Amides of β-(3.5-di-tert-butyl-4-hydroxyphenyl)Dropionic acid e.g. N,N′-bis(3,5-di-tertbutyl4-hydroxyphenylpropionyl)hexamethylenediamine, N,N′-bis(3, 5-di-tert-butyl4-hydroxyphenylpropionyl)trimethylenediamide, N,N′-bis(3,5-di-tert-butyl4-hydroxyphenylpropionyl)hydrazide, N,N′-bis[2-(3-[3,5-di-tert-butyl4-hydroxyphenyl]propionyloxy)ethyl]oxamide (Naugard®XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-pphenylenediamine, N,N′-bis(1-methylheptyl)-p-phenylenediamine, N,N′-dicyclohexyl-pphenylenediamine, N,N′-diphenyl-p-phenylenediamine, N,N′-bis(2-naphthyl)-pphenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-disec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyidiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6di-tert-butyl4-dimethylaminomethylphenol, 2,4′-diaminodiphenylmethane, 4,4′-diaminodiphenylmethane, N,N, N′,N′-tetramethyl4,4′-diaminodiphenylmethane, 1,2-bis[(2-methylphenyl)amino]ethane, 1,2-bis(phenylamino)propane, (o-tolyl)biguanide, bis[4-(1,′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyidiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-buty/tert-octylphenothiazin s, a mixture of mono- and dialkylated tert-octylphenothiazines, N-allylphenothiazin, N,N,N′,N′-tetraphenyl-1,4-diaminobut-2-ene, N,N-bis(2,2,6,6-t tramethylpiperid-4-yl-hexamethylenediamine, bis(2,2,6,6-tetramethyipiperid-4-yl)sebacate, 2,2,6,6-tetramethylpiperidin4-one, 2,2,6,6-tetramethylpiperidin4-ol.

2. UV absorbers and light stabilisers

2.1. 2-(2′-Hydroxyphenyl)benzotriazoles, for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-ditert-butyl-2′-hydroxyphenyl)-5-chlorobenzotriazole, 2-(3′-tert-butyl-2′-hydroxy-5′-methylphenyl)-5chlorobenzotriazole, 2-(3′-sec-butyl-5′-tert-butyl-2′-hydroxyphenyl)benzotriazole, 2-(2′-hydroxy4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂]₂, where R=3′-tert-butyl4′-hydroxy-5′-2H-benzotriazol-2-ylphenyl, 2-[2′-hydroxy-3′-(α,α-imethylbenzyl)-5′-(1,1,3,3-tetramethylbutyl)phenyl]-benzotriazole; 2-[2′-hydroxy-3′-(1,1,3,3-tetramethylbutyl)-5′-(α,α-dimethylbenzyl)phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5di-tert-butyl hydroxybenzoate, hexadecyl 3,5di-tert-butyl4-hydroxybenzoate, octadecyl 3,5-di-tert-butyl4-hydroxybenzoate, 2-methyl-4,6-di-tert-butylphenyl 3,5-di-tert-butylphydroxybenzoate.

2.4. Acrylates, for example ethyl α-cyano-β,β-diphenylacrylate, isooctyl α-cyano-β,β-diphenylacrylate, methyl (α-carbomethoxycinnamate, methyl α-cyano-β-methyl-pmethoxycinnamate, butyl α-cyano-β-methyl-p-methoxycinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tertbutylbenzylphosphonic acid, nickel complexes of ketoximes, e.g. of 2-hydroxy-4-methylphenylundecylketoxime, nickel complexes of 1-phenylilauroyl-5-hydroxypyrazole, with or without additional ligands.

2.6. Sterically hindered amines, for example bis(2,2,6,6-tetramethyl4-piperidyl)sebacate, bis(2,2,6,6-tetramethyl4-piperidyl)succinate, bis(1,2,2,6,6-pentamethyl4-piperidyl)sebacate, bis(1-octyloxy-2,2,6,6-tetramethyl4piperidyl)sebacate, bis(1,2,2,6,6-pentamethyl4-piperidyl) n-butyl-3,5-di-tert-butyl-4-hydroxybenzylmalonate, the condensate of 1-(2-hydroxyethyl)-2,2,6,6-tetramethyl4-hydroxypiperidine and succinic acid, linear or cyclic condensates of N,N′-bis(2,2,6,6-tetramethyl4-piperidyl)hexamethylenediamine and 4-tert-octylamino-2,6-dichloro-1,3,5-triazine, tris(2,2,6,6-tetramethyl4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)-malonate, 3-n-ctyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-ichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)-ethane, the condensate of 2-chloro4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4,5]decane-2,4-dione, 3-dodecyl-1-(2,2,6,6-tetramethyl4-piperidyl)pyrrolidine-2,5-dione, 3-dodecyl-1-(1,2,2,6,6-pentamethyl-4-piperidyl)pyrrolidine-2,5-dione, a mixture of 4hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl4-piperidyl)-n-dodecylsuccinimide, 2-undecyl-7,7,9,9-tetramethyl-1-oxa-3,8-diaza4-oxo-spiro[4,5]decane, a reaction product of 7,7,9,9-tetramethyl-2-cycloundecyl-1-oxa-3,8-diaza4-oxospiro-[4,5-decane and epichlorohydrin, 1,1-bis(1,2,2,6,6-pentamethyl4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy4-(2,2,6,6-tetramethyl-4-piperidyl)]siloxane, a reaction product of maleic acid anhydride-a-olefin copolymer with 2,2,6,6-tetramethyl aminopiperidine or 1,2,2,6,6-pentamethyl-4-aminopiperidine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxydisubstituted oxanilides and mixtures of o- and p-ethoxy-disubstituted oxanilides.

2.8. 2-(2-Hydroxyphenyl)-1.3. 5-triazines, for example 2,4,6-tris(2-hydroxy-4-octyloxyphenyl)-1,3,5triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-(2-hydroxy4-(2-hydroxy-3-butyloxypropoxy)phenyl]-4,6-bis(2,4dimethyl)-1,3,5-triazine, 2-[2-hydroxy4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]4,6-bis(2,4-dimethylphenyl)-1,3,5-triazine, 2-[2-hydroxy-(2-hydroxy-3-dodecyloxypropoxy)phenyl]-4,6-bis(2,4-dimethylphenyl)-1,3,5-triazine, 2-(2-hydroxy4-hexyloxy)phenyl-4,6-diphenyl-1,3,5-triazine, 2-(2-hydroxy-4-methoxyphenyl)4,6-diphenyl-1,3,5-triazine, 2,4,6-tris[2-hydroxy4-(3-butoxy-2-hydroxypropoxy)phenyl]-1,3,5-triazine, 2-(2-hydroxyphenyl)4-(4-methoxyphenyl)6-phenyl-1,3,5-triazine, 2-{2-hydroxy4-[3-(2-ethylhexyl-1-oxy)-2-hydroxypropyloxy]phenyl}4,6-bis(2,4-dimethylphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl~hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyidialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-dicumylphenyl)pentaerythritol diphosphite, bis(2,6-di-tert-butyl4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tertbutyl-6-methylphenyl)methyl phosphite, bis(2,4-di-tert-butyl6-methylphenyl)ethyl phosphite, 6-fluoro-2,4,8,10tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5butyl-5-ethyl-2-(2,4,6-tri-tert-butylphenoxy)-1,3,2-dioxaphosphirane.

The following phosphites are especially preferred:

Tris(2,4-di-tert-butylphenyl) phosphite (Irgafos®168, Ciba-Geigy), tris(nonylphenyl) phosphite,

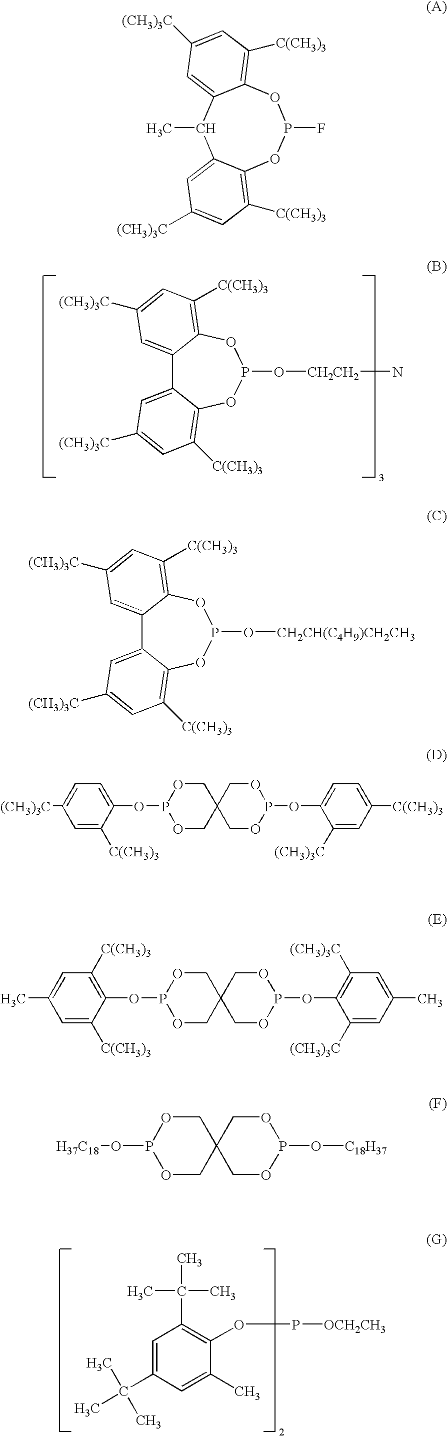

5. Hydroxylamines, for example N,N-dibenzylhydroxylamin, N,N-diethylhydroxylamin, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example N-benzyl-alpha-phenylnitrone, N-ethyl-alpha-methylnitrone, N-octylalpha-heptylnitrone, N-lauryl-alpha-undecyinitrone, N-tetradecyl-alpha-tridecylnitrone, N-hexadecyl-alpha-pentadecylnitrone, N-octadecyl-alpha-heptadecylnitrone, N-hexadecyl-alpha-heptadecyinitrone, N-ocatadecyl-alpha-pentadecyinitrone, N-heptadecyl-alpha-heptadecyinitrone, N-octadecyl-alpha-hexadecylnitrone, nitrone derived from N,N-dialkylhydroxylamine derived from hydrogenated tallow amine.

7. Thiosynergists, for example dilauryl thiodipropionate or distearyl thiodipropionate.

8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

9. Polyamide stabilisers, for example copper salts in combination with iodides and/or phosphorus compounds and salts of divalent manganese.

10. Basic co-stabilisers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4bis(3′,4′-dimethylbenzylidene)sorbitol, 1,3:2,4di(paramethyl-dibenzylidene)sorbitol, and 1,3:2,4di(benzylidene)sorbitol.

12. Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pt, Nos. 4,325,863; 4,338,244; 5,175,312; 5,216,052; 5,252,643; DE-A4316611; DE-A4316622; DE-A4316876; EP-A-0589839 or EP-A-0591102 or 3-[s(2-acetoxyethoxy)-phenyl]-5,7-di-tert-butylbenzofuran-2-one, 5,7-di-tert-butyl-3-[4(2-stearoyloxyethoxy)phenyl]-benzofuran-2-one, 3,3′-bis[5,7-di-tert-butyl-3-(4-[2-hydroxyethoxy]phenyl)benzofuran-2-one]-5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one.

The incorporation of the biocides and other additives into the plastics can be carried out in any temperature-controllable vessel having a stirring device. It may be, for example, a closed apparatus, such as a kneader, mixer or stirring vessel. The incorporation can also be carried out in an extruder or kneading device, it being immaterial whether the operation is carried out under an inert atmosphere or in the presence of atmospheric oxygen.

Thermoplastic plastics are usually melted during processing, the biocide then being distributed in the plastics. The processing temperatures depend upon the thermoplastic plastics and are generally from 150° C. to 280° C.

The mass transfer apparatus in which the active plastics internal elements are used is very especially a gas scrubber, the liquid phase consisting substantially of water.

It is also possible for amounts of water-miscible solvents to be added to the water. Examples are alcohols, such as methanol, ethanol and ethylene glycol. Further additives are, for example, surface-active substances that ensure improved wetting of the surfaces. They may be anionic, cationic or non-ionic surfactants, and also acid or alkaline substances with which a desired pH value can be established and optionally also buffered. Suitable substances are commercially available.

The invention relates also to the use of 2,3,5,6-tetrachloro4-(methylsulfonyl)-pyridine, 2,4,4′-trichloro-2′-hydroxydiphenyl ether, 4,4′-dichloro-2-hydroxydiphenyl ether, 2,2′-methylenebis-(4-chlorophenol), 4-(2-tert-butyl-5-methylphenoxy)-phenol, 3-(4chlorophenyl)-1-(3,4dichlorophenyl)urea or 2,4,6-trichlorophenol in active plastics internal elements for the cleaning of gas or air in humidifiers of process gases, gas scrubbers or exhaust air scrubbers in which a gas phase and a liquid phase are in contact with one another.

The following Examples illustrate the invention.

### EXPERIMENTAL ARRANGEMENT AND PROCEDURE

Two identical absorption columns, filled with the two different kinds of packings (according to the invention and without biocide), are supplied in equal parts over a prolonged period with a constant stream of air containing organic contaminants (methanol). In order to remove the contaminant loading, a circulating flow of water is trickled through the columns and their packings, a small portion of the water overflowing and being replaced continuously with fresh water. The absorbers are so configured that, at least initially, the treated exhaust air flow is virtually clean.

In order to determine the effectiveness of the differently prepared packings, the pressure drop over the packing layer is measured from time to time in each of the two columns. In addition, the columns are briefly disassembled, the water located therein drained off and the weight of the columns determined. They are then re-inserted into the apparatus and the experiment is continued.

| Apparatus data | | |
|---|---|---|
| Dimensions | | |
| column diameter | 190 | mm |
| packed height | 1200 | mm |
| packing volume | 23 | litres |
| Gas supply: | | |
| air throughput | 100 | m³/h |
| rate for unobstructed column | 1 | m/s |
| Water trickling | | |
| amount circulated | 700 | l/h |
| density of trickling | 25 | m³/m²h |
| Duration of experiment | 81 | days |

Packings

Packings are produced from polypropylene in an injection moulding process in accordance with U.S. Pat. No. 4,072,736 (commercial product from CIBA Spezialitatenchemie, Dept. Environmental Technology). One series of packings contains 0.1 % by weight, based on the polymer weight, of Irgaguard B 1000 (2,4,4′-trichloro-2′-hydroxydiphenyl ether, commercial product from Ciba Spezialitatenchemie), a second series of packings contains no biocide.

The results are shown in Tables 1 and 2.

TABLE 1
Pressure drop in mm water column as function of operating time
Pressure drop in mm water column

| Days treatment | Untreated packings | Packings with Irgaguard B 1000 |
|---|---|---|
| 0 | 20 | 20 |
| 20 | 20 | 18 |
| 50 | 30 | 24 |
| 75 | 80 | 18 |

TABLE 2
Increase in weight as function of operating time
Increas in weight in kg

| Days treatment | Untreated packings | Packings with Irgaguard B 1000 |
|---|---|---|
| 0 | 0 | 0 |
| 14 | 0.3 | 0.3 |
| 28 | 3 | 0.4 |
| 40 | 3.8 | 0 |

Both the pressure drop and the increase in weight over time are very different in the two cases. In the case of the treated packings, no increased pressure drop resulting from clogging is ascertained and accordingly no increase in weight resulting from microorganisms or from the water bonded in the biofilm is ascertained.

The build-up of biomaterial on the untreated packings is also clearly discernible on visual inspection, the packings are almost completely filled (overgrown) with white gelatinous biomass, while the packings that have been provided with biocide have the same appearance at the beginning and end of the experiment.

What is claimed is:

1. A biocide-containing active plastics internal element for the cleaning of gas or air in humidifiers of process gases, gas scrubbers or exhaust air scrubbers in which a gas phase and a liquid phase are in contact with one another, the biocide being selected from the group consisting of 2,3,5,6-tetrachloro(methylsulfonyl)-pyridine, 2,4,4′-trichloro-2′-hydroxydiphenyl ether, 4,4′-dichloro-2-hydroxydiphenyl ether, 4-(2-tert-butyl-5-methylphenoxy)-phenol, 2,2′-methylenebis(4-chlorophenol), 3-(4-chlorophenyl)-1-(3,4-dichlorophenyl)urea and 2,4,6-trichlorophenol.

2. A biocide-containing active plastics internal element according to claim 1, the active plastics internal element being a plastics packing, a gas guide insert or a plastics droplet separator.

3. A biocide-containing active plastics internal element according to claim 1 for the cleaning of gas and air in gas scrubbers or exhaust air scrubbers.

4. A biocide-containing active plastics internal element according to claim 1 wherein the biocide is 2,4,4′-trichloro-2′-hydroxydiphenyl ether or 4,4′-dichloro-2-hydroxydiphenyl ether.

5. A biocide-containing active plastics internal element according to claim 1 which is a plastics packing.

6. A biocide-containing packing according to claim 5 which consists essentially of parallel rods, the lengths of which are such that the overall shape of the packing is substantially spherical or ellipsoidal.

7. A biocide-containing active plastics internal element according to claim 1 wherein the biocide is present in an amount of from 0.001 to 5 %, based on the weight of the plastics.

8. A biocide-containing active plastics internal element according to claim 1 which is manufactured from a polyolefin.

9. A biocide-containing active plastics internal element according to claim 8 which is manufactured from poly thylene or polypropylene.

10. Use of 2,3,5,6tetrachloro4(methylsulfonyl)-pyridine, 2,4,4′-trichloro-2′-hydroxydiphenyl ether, 4,4′-dichloro-2-hydroxydiphenyl ether, 2,2′-methylenebis(4-chlofophenol), 4-(2-tertbutyl-5-methylphenoxy)-phenol, 3(4-chlorophenyl)-1-(3,4-dichlorophenyl)urea or 2,4,6-trichlorophenol in active plastics internal elements for the cleaning of gas or air in humidifiers of process gases, gas scrubbers or exhaust air scrubbers in which a gas phase and a liquid phase are in contact with one another.
